(19) United States
(12) Patent Application Publication
(10) Pub. No.: US 2014/0147277 A1
(43) Pub. Date: May 29, 2014

(54) ROTOR BLADE SYSTEM FOR HELICOPTER

(71) Applicant: Tadashi IWATA, Yamaguchi (JP)

(72) Inventor: Tadashi IWATA, Yamaguchi (JP)

(21) Appl. No.: 14/085,961

(22) Filed: Nov. 21, 2013

(30) Foreign Application Priority Data
Nov. 26, 2012 (JP) 2012-257490

(51) Int. Cl. B64C 27/37; B64D 17/80

(52) U.S. Cl. CPC B64C 27/37; B64D 17/80
USPC 416/146 R

(57) ABSTRACT

In a rotor blade system for helicopter including a rotor mast vertically disposed on an upper part of a fuselage in the vicinity of its position of the center of gravity, even-ordered rotor blades supported on their base portions by the rotor mast, and a power source rotary-driving the rotor mast to rotate the plural rotor blades around an axis of the rotor mast, the even-ordered rotor blades are arranged at equal intervals in a circumferential direction of the rotor mast provided that each two rotor blades hold the rotor mast therebetween and extend in a diameter direction of the rotor mast as a pair, and that the paired two rotor blades are integrally joined with each other at their base portions and swingably supported around a common axis extending in the diameter direction of the rotor mast by a support shaft perpendicularly disposed in the rotor mast.

### TECHNICAL FIELD

This invention relates to a rotor blade system for helicopter, and more particularly to a rotor blade system providing not only a sufficient lift at a low-speed rotation but also a stable lift against the wind.

### RELATED ART

The conventional rotor blade system for helicopter usually provides a lift by rotating a plurality of rotor blades around a rotor mast as disclosed, for example, in Patent Document 1, wherein the rotor mast is vertically disposed on an upper part of a fuselage in the vicinity of its position of the center of gravity and swingably supports each base portion of the plural rotor blades around an axis extending radially from the rotor mast and is rotary-driven by a power source such as engine or the like.

Also, the each base portion of the rotor blades is connected to an annular swash plate enclosing the rotor mast and the swash plate is moved up and down to the rotor mast, whereby a blade pitch of each rotor blade (swinging angle) is increased or decreased as a whole of the plural rotor blades to increase or decrease a lift wholly. Further, the swash plate is tilted to the rotor mast to decrease the blade pitch of a rotor blade rotating in the direction of forward movement to the fuselage and to increase the blade pitch of a rotor blade rotating in the direction of backward movement to the fuselage, whereby the lifts of the rotor blades located on left and right of the fuselage are made equal.

However, since the conventional rotor blades for helicopter take such an elongate shape that a ratio of length to width is large, an area per one rotor blade is small and hence sufficient lift is obtained only at a high-speed rotation, which causes a problem of generating intense noise.

To this end, there have been proposed a rotor blade shape of wide sweptback blade having a relatively small ratio of length to width as disclosed in Patent Document 2, a double helical and semi-circular rotor blade shape as disclosed in Patent Document 3, and so on.

### PRIOR ART DOCUMENTS

### Patent Documents

Patent Document 1: JP-A-H11-342899

Patent Document 2: JP-A-2009-126507

Patent Document 3: JP-A-H10-236396

### SUMMARY OF THE INVENTION

### Task to be Solved by the Invention

In all of the wide type rotor blades disclosed in the above patent documents, however, since an elevation angle is fixed, there is a problem that if the rotor blade is accidentally subjected to a strong opposing wind, the rotor blade rotating in the direction of forward movement is strongly uplifted, while the rotor blade rotating in the direction of backward movement is strongly pushed down and hence the balance of lift between the right and left sides of the fuselage is lost and the control of the fuselage is difficult.

### Solution for Task

The inventor have made various studies on a technology capable of overcoming the problem inherent to the above conventional techniques, and as a result the invention according to the following summery and construction has been accomplished.

That is, the rotor blade system for helicopter according to the invention is a rotor blade system for helicopter comprising a rotor mast vertically disposed on an upper part of a fuselage in the vicinity of its position of the center of gravity, even-ordered rotor blades supported on their base portions by the rotor mast, and a power source rotary-driving the rotor mast to rotate the plural rotor blades around an axis of the rotor mast, characterized in that the even-ordered rotor blades are arranged at equal intervals in a circumferential direction of the rotor mast provided that each two rotor blades hold the rotor mast therebetween and extend in a diameter direction of the rotor mast as a pair, and that the paired two rotor blades are integrally joined with each other at their base portions and swingably supported around a common axis extending in the diameter direction of the rotor mast by a support shaft perpendicularly disposed in the rotor mast, and that the support shaft gives an elevation angle from horizontal posture to the rotor blade and supports the rotor blade at a position between front and rear blade ends decreasing the elevation angle when the rotor blade is subjected to wind pressure from before the rotation direction of the rotor blade, and that the rotor blade system further comprises a mast-tilting support mechanism having a semispherical bearing and tiltably supporting the rotor mast on the upper part of the fuselage in all directions of right-left sides and front of the fuselage, and that the rotor mast comprises a rotary shaft rotating the rotor blades around an axis of the rotor mast and a fixed shaft located inside the rotary shaft and supported so as not to rotate to the fuselage, and that a parachute ejection device is provided on an upper end part of the fixed shaft of the rotor mast.

### Effect of the Invention

In the rotor blade system for helicopter according to the invention, the even-ordered rotor blades are arranged at equal intervals in a circumferential direction of the rotor mast provided that each two rotor blades sandwich the rotor mast and extend in a diameter direction of the rotor mast as a pair, and the paired two rotor blades are integrally joined with each other at their base portions and swingably supported around a common axis extending in the diameter direction of the rotor mast by a support shaft perpendicularly disposed in the rotor mast, and the support shaft gives an elevation angle from horizontal posture to the rotor blade and supports the rotor blade at a position between front and rear blade ends decreasing the elevation angle when the rotor blade is subjected to wind pressure from before the rotation direction of the rotor blade.

Thus, if the fuselage ascends right above at a dead calm state or if a dead calm is relatively formed by subjecting the fuselage to a strong following wind from behind during the forward movement, each of the paired two rotor blades is subjected to a wind pressure with equal strength in response to the rotation speed from before the rotation direction, whereby force reducing the elevation angle is balanced around the support shaft and hence these rotor blades are rotated at the same elevation angle from each other to provide the same lift in all directions of the fuselage. However, if the fuselage is usually subjected to a wind from before during the forward movement or if the fuselage is accidentally subjected to a strong opposing wind, a rotor blade rotating in the forward direction among the paired two rotor blades increases wind pressure from before in the rotation direction through the wind from before the fuselage to decrease the elevation angle, while another rotor blade rotating in backward direction decreases wind pressure from before in the rotation direction to increase the elevation angle associated with the decrease of the elevation angle of the above rotor blade.

In the rotor blade system for helicopter according to the invention, therefore, if the fuselage is usually subjected to a wind from before during the forward movement or if the fuselage is accidentally subjected to a strong opposing wind, the increase of lift in the rotor blade rotating in the forward direction is suppressed, while the decrease of lift in the rotor blade rotating in the backward direction is suppressed, so that the balance of lift between the right and left of the fuselage can be maintained. Similarly, even if a strong following wind is accidentally applied from behind the fuselage, the balance of lift between the right and left of the fuselage can be maintained, or even if a strong side wind is accidentally applied from any side of the right and left of the fuselage, the balance of lift between the front and rear of the fuselage can be maintained. Therefore, even in a helicopter flying silently by slowly rotating rotor blades of a wide shape, the control of the fuselage can be easily conducted when a gust is caught. In such a helicopter, another propulsion means such as propeller, jet engine or the like may be used for forward movement or braking of the fuselage, and also the above propulsion means such as propeller or jet engine or a vertical fin provided with a rudder may be used for right-left turning of the fuselage.

Also, the rotor blade system for helicopter according to the invention comprises the mast tilting support mechanism having a semispherical bearing and tiltably supporting the rotor mast on the upper part of the fuselage in all directions of right-left sides and front of the fuselage as mentioned above, so that if the fuselage is subjected to a strong gust hardly dealing with only the change of elevation angle of the rotor blade from right-left sides or behind the fuselage, only the rotor mast can be titled in an opposite direction to keep the fuselage horizontally, while the base portion of the rotor blade of a wide shape or the base portion of the rotor mast can be prevented from breakage due to concentration of load.

Moreover, in the rotor blade system for helicopter according to the invention, it is further preferable that the mast tilting support mechanism is provided with a mast support wire supporting the rotor mast connected to the fuselage for preventing the rotor mast from tilting behind the fuselage. In this case, if the fuselage is subjected to the strong gust from before, tilting backwards of only the rotor mast can be prevented to avoid obstruction of forward flying of the fuselage, while the base portion of the rotor blade of a wide shape or the base portion of the rotor mast can be prevented from breakage due to concentration of load.

Further, in the rotor blade system for helicopter according to the invention, the rotor mast comprises a rotary shaft rotating the rotor blades around an axis of the rotor mast and a fixed shaft located inside the rotary shaft and supported so as not to rotate to the fuselage, and the parachute ejection device is provided on an upper end part of the fixed shaft of the rotor mast, so that the parachute can be ejected right above without twisting to the rotor blades, ropes of the parachute can be prevented from twisting to the fuselage even though the rotor blades are rotated, and the fuselage can be landed safely at a time of causing trouble of a driving source or the like.

In the rotor blade system for helicopter according to the invention, the rotor blades are preferable to be used as two pairs. When the two pairs of the rotor blades are rotated in opposing directions from each other, there is no rotation of the fuselage due to reaction force of rotary driving of the rotor blades.

### BRIEF DESCRIPTION OF THE DRAWINGS

FIGS. 1(a) and 1(b) are plan view and front view illustrating a helicopter provided with a rotor blade system for helicopter according to the invention, respectively. (In the front view, a state of opening a parachute is shown by a phantom line.)

FIG. 2 is a plan view illustrating a shape of rotor blades in the above rotor blade system for helicopter.

FIG. 3(a) is a side view illustrating rotor blades in the rotor blade system for helicopter at a windless state to a fuselage, and FIG. 3(b) is a side view illustrating a state of swinging rotor blades when wind is applied to a fuselage, and FIG. 3(c) is a plan view explaining a swingable supporting state of rotor blades.

FIG. 4(a) is a side view illustrating rotor blades in the rotor blade system for helicopter at a windless state to a fuselage, and FIG. 4(b) is a side view illustrating a state of swinging rotor blades when wind is applied to a fuselage and stopping to a swing limit position by a stopper.

FIG. 5 is a front view of the rotor blade system for helicopter viewing from a front of a fuselage.

FIG. 6 is a section view of the rotor blade system for helicopter viewing from a side of a fuselage.

FIG. 7 is a plan view illustrating a power transmission system for the rotor blade system for helicopter omitting a cover.

FIG. 8 is a section view illustrating a parachute ejecting device disposed on an upper end part of the rotor blade system for helicopter viewing from a side of a fuselage.

FIG. 9 is a plan view illustrating an operation state of the rotor blade system for helicopter viewed from above a fuselage.

FIG. 10 is a plan view illustrating another rotor blade system for helicopter according to the invention.

FIG. 11 is a section view illustrating a main part of the above rotor blade system for helicopter viewing from a side of a fuselage.

### EMBODIMENTS FOR CARRYING OUT THE INVENTION

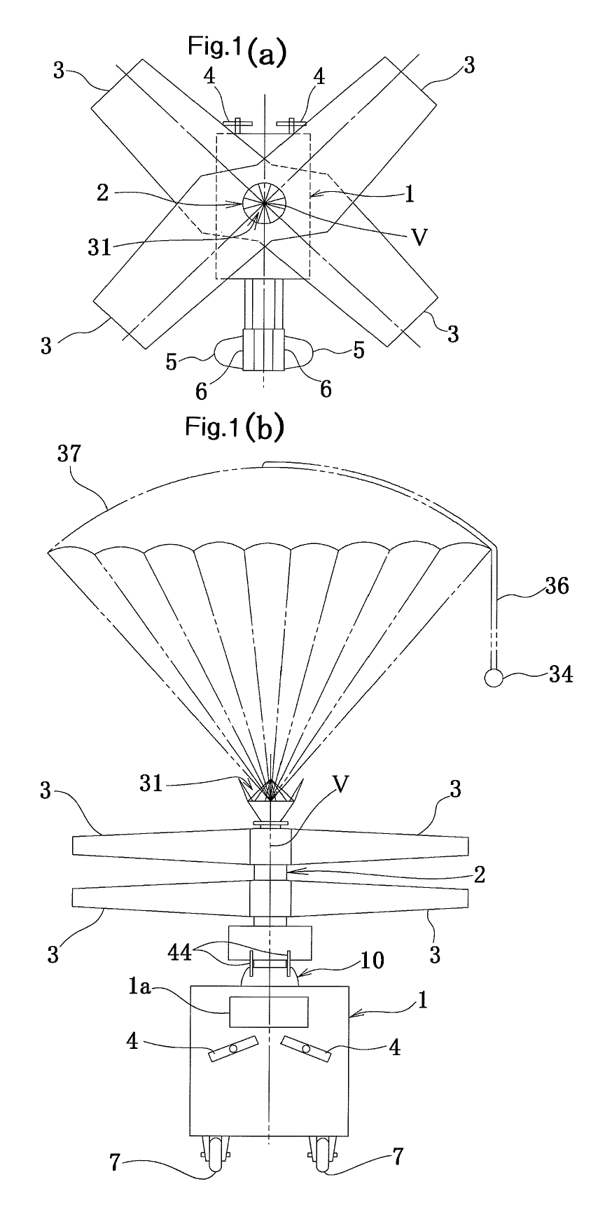

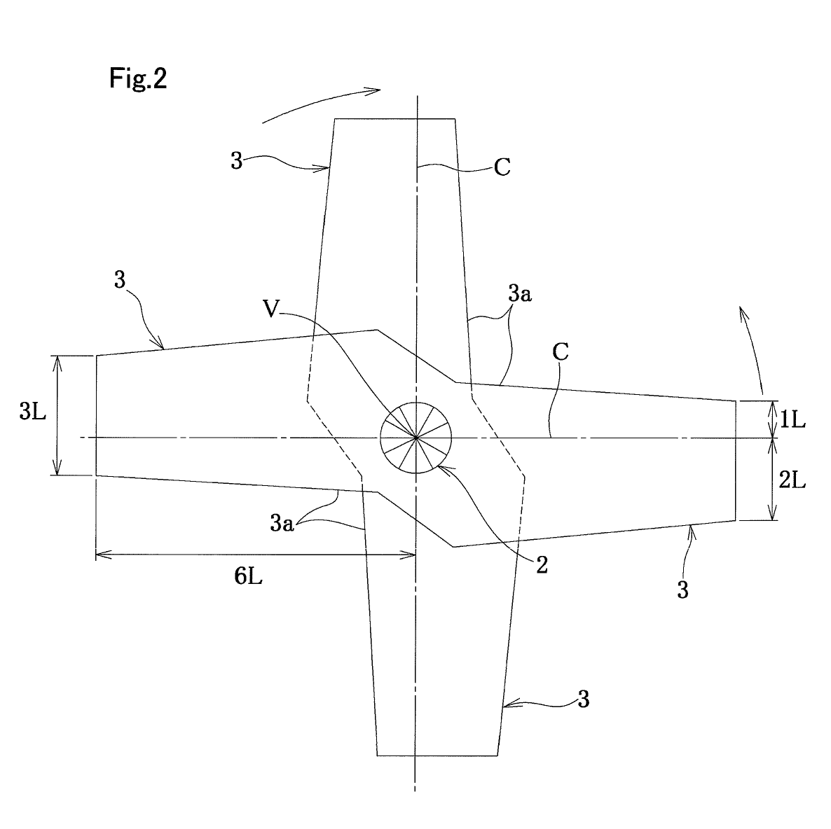

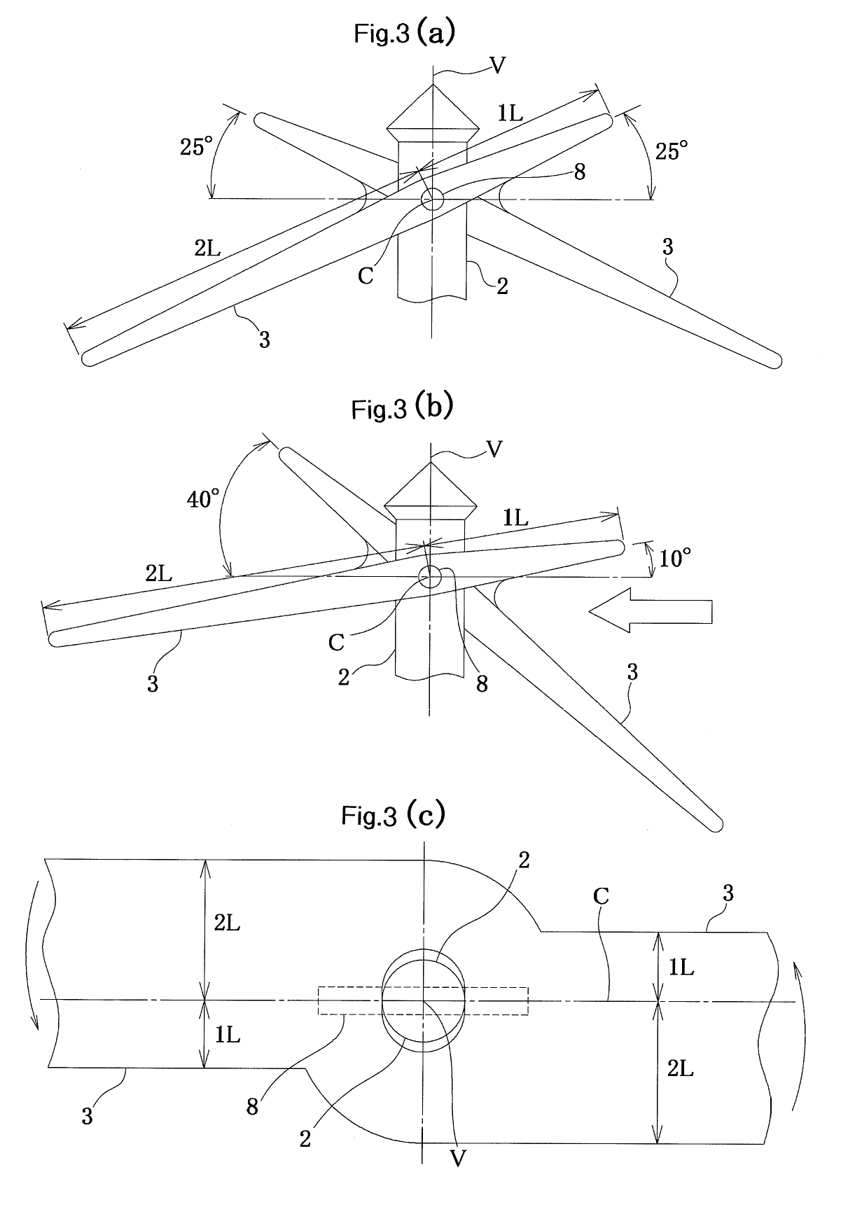

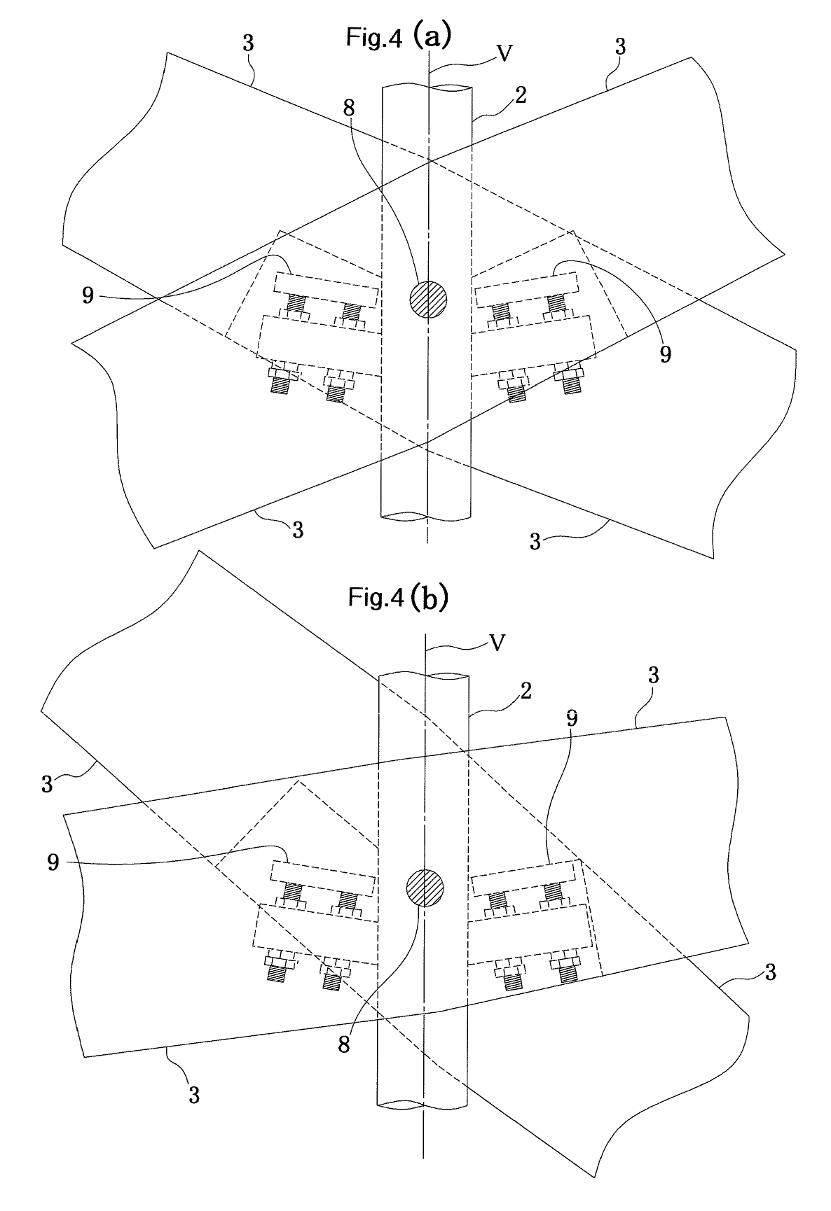

An embodiment of the invention will be described in detail with reference to examples based on the drawings below. Here, FIGS. 1(a) and 1(b) are plan view and front view illustrating a helicopter provided with an example of the rotor blade system for helicopter according to the invention, respectively (In the front view, a state of opening a parachute is shown by a phantom line), and FIG. 2 is a plan view illustrating a shape of rotor blades in the rotor blade system for helicopter, FIG. 3(a) is a side view illustrating rotor blades in the rotor blade system for helicopter at a windless state to a fuselage, and FIG. 3(b) is a side view illustrating a state of swinging rotor blades when wind is applied to a fuselage, and FIG. 3(c) is a plan view explaining a swingable supporting state of rotor blades, and FIG. 4(a) is a side view illustrating rotor blades in the embodiment of the rotor blade system for helicopter at a windless state to a fuselage, and FIG. 4(b) is a side view illustrating a state of swinging rotor blades when wind is applied to a fuselage and stopping to a swing limit position by a stopper, wherein numeral 1 is a fuselage of a helicopter, numeral 2 a rotor mast and numeral 3 a rotor blade.

As shown in FIG. 1, the rotor blade system for helicopter comprises a rotor mast 2 vertically disposed on an upper part of a fuselage 1 in the vicinity of its position of the center of gravity, four rotor blades 3 as two pairs, base portion 3a of each of the rotor blades being supported by the rotor mast 2, and an engine (not shown) mounted on the fuselage 1 as a power source for rotary-driving a rotary shaft of the rotor mast 2 as mentioned later to rotate the four rotor blades 3 around an axis V of the rotor mast 2. Further, the helicopter provided with the rotor blade system for helicopter comprises two sets of propellers 4 for forward movement arranged on a front part of the fuselage 1 and rotary-driven by the engine, a horizontal stabilizer 5 and two vertical fins 6 each arranged on a rear part of the fuselage 1 for stabilizing a flying posture and flying direction of the flying fuselage 1, and wheels 7 arranged on a bottom of the fuselage 1 for landing and running the fuselage 1 on ground. Moreover, the flying direction of the helicopter is mainly changed by a rudder (not shown) disposed in the vertical fin 6. Also a window 1a for getting a field of view of a passenger such as a pilot or the like is disposed on at least a front part of the fuselage 1.

In this embodiment, the rotor blade system for helicopter comprises the two pairs each made of two rotor blades 3 holding the rotor mast 2 therebetween and extending in a diameter direction of the rotor mast 2 and arranged at equal intervals of 180° in a circumferential direction of the rotor mast 2 as shown in FIGS. 2 and 3. The paired two rotor blades 3 are integrally joined with each other at their base portions 3a and swingably supported around a common axis C extending in the diameter direction of the rotor mast 2 by a support shaft 8 disposed in the rotor mast 2, and the support shaft 8 gives an elevation angle from horizontal posture to the rotor blade 3 and supports the rotor blade 3 at a position between front and rear blade ends decreasing the elevation angle when the rotor blade 3 is subjected to wind pressure from before the rotation direction of the rotor blade 3, i.e. at a position between front and back blade ends of front side size 1L in the rotation direction of the axis C and rear side size 2L in the rotation direction of the axis C with respect to a size 3L between the front and back ends in the illustrated example. (L is an arbitrary size, and this size L may be, for example, 50 cm in a small-size helicopter and 1 m in a large-size helicopter.)

When the rotor blade system for helicopter is at a state of ascending the fuselage 1 right above without wind or hovering in a constant place, as shown in FIG. 3(a), the paired two rotor blades 3 have an equal elevation angle from horizontal posture, for example, an elevation angle of 25° since they are subjected to equal wind pressure from before the rotation direction from each other. When the rotor blades 3 are subjected to opposing wind from before the fuselage 1 during usual flying or accidentally subjected to strong opposing wind, as shown in FIG. 3(b), wind pressure of the opposing wind is largely applied to a lower portion of the rotor blade below the axis C rather than an upper portion thereof to generate such a swinging torque (clockwise torque around the support shaft 8 in FIGS. 3(a) and (b)) that an elevation angle of a rotor blade 3 going against the opposing wind (front side of the rotor mast 2 in FIG. 3(b)) is decreased to, for example, 10° and an elevation angle of a rotor blade 3 running away from the opposing wind (far side of the rotor mast 2 in FIG. 3(b)) is increased to, for example, 40°.

By this swinging torque, the increase of lift is suppressed in the rotor blade 3 going against the opposing wind with relatively increasing airspeed and at the same time the decrease of lift in the rotor blade running away from the opposing wind with relatively decreasing airspeed is suppressed, whereby the balance of lift between right and left of the fuselage 1 is maintained. In turn, the balance of lift between right and left of the fuselage 1 is maintained even when the fuselage 1 is accidentally subjected to strong following wind from behind, and further the balance of lift between front and back of the fuselage 1 is maintained even when the fuselage 1 is subjected to strong crosswind from any right and left sides.

Moreover, swinging limit in each of the rotor blades 3 is controlled to a given position by contacting with a stopper 9 arranged on the rotor mast 2 at an adjustable position through screws, whereby a maximum value of the elevation angle of each rotor blade 3 is controlled to a given angle. Also, the paired two rotor blades 3 are made to provide equal elevation angle from each other by weight balance around the support shaft 8 (axis C) when they are not rotated at a dead calm state to the fuselage 1 or by the swinging torque based on wind pressure applied to the each rotor blade 3 from before the rotation direction during the rotation of the rotor blades.

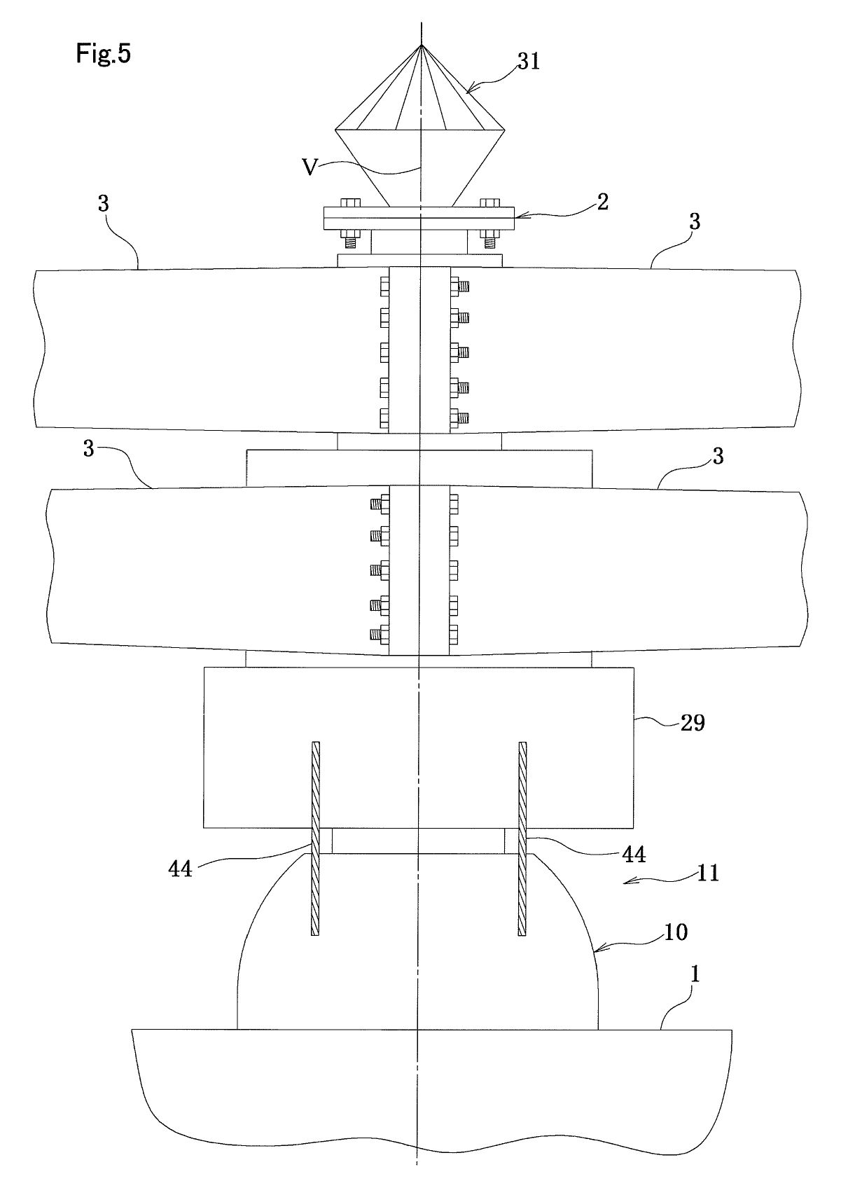

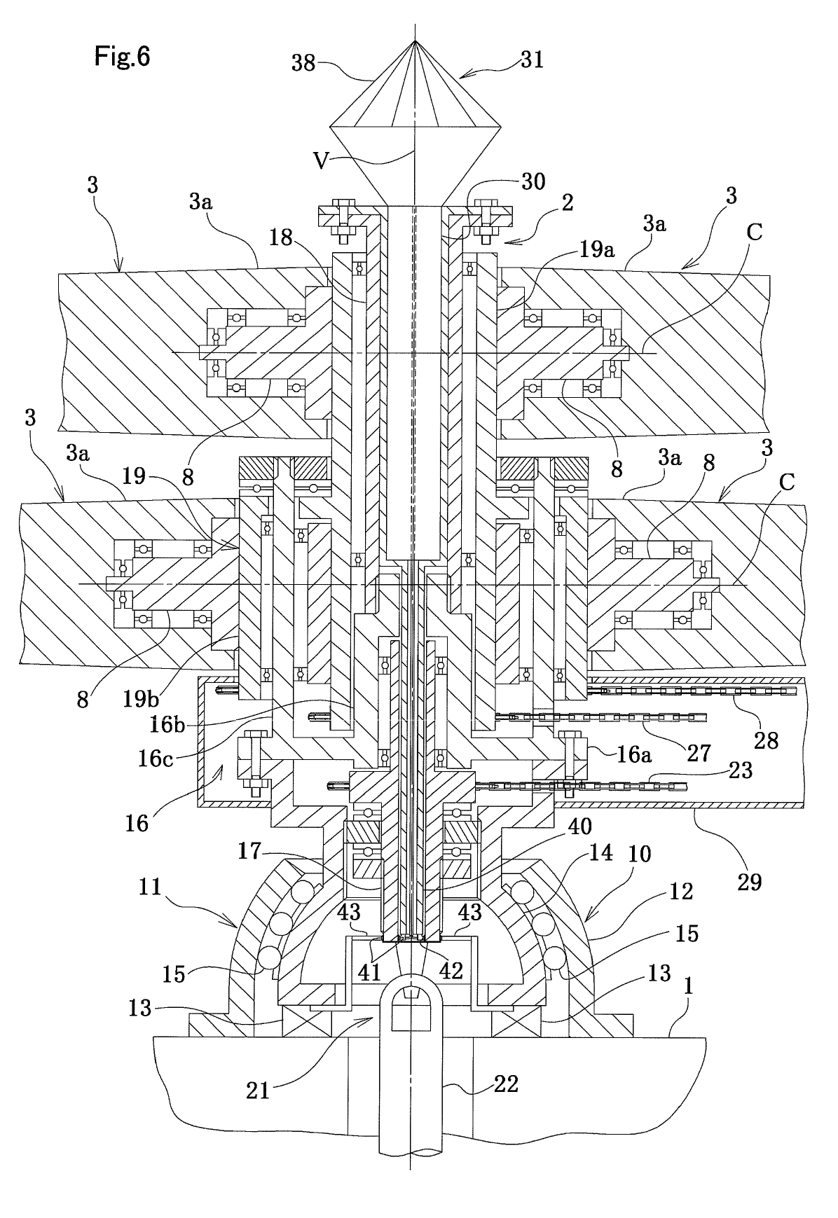

FIG. 5 is a front view of the rotor blade system for helicopter viewing from the front of the fuselage, and FIG. 6 is a section view of the rotor blade system for helicopter viewing from the side of the fuselage. The rotor mast 2 comprises a mast-tilting support mechanism 11 with a semispherical bearing 10 swingably supporting a base portion of the rotor mast 2 in all directions to the fuselage 1. The semispherical bearing 10 comprises a substantially semispherical shell-like outer housing of, for example, dual partitioning type fixed on an upper part of the fuselage 1 in the vicinity of its position of the center of gravity, a substantially semispherical shell-like inner housing 14 arranged inside the outer housing 12 as a base portion of the rotor mast 2 and pushed by plural springs 13 toward the outer housing 12, a plurality of steel balls rotatably held in a recess of a holder around the inner housing 14 and interposing between the outer housing 12 and the inner housing 14 to transmit lift of the rotor blades 3 applied from the rotor mast 2 through the inner housing 14 toward the outer housing 12, and a gimbal mechanism (not shown) arranged between the outer housing 12 and the inner housing 14 and swingably connecting the inner housing 14 to the outer housing 12 around two axes bisecting each other at right angle and inhibiting rotation of the inner housing 14 to the outer housing 12 around the axis V of the rotor mast 2 while allowing the swing of the inner housing 14 to the outer housing 12.

Further, the rotor mast 2 is provided with a lower fixed shaft 16. The lower fixed shaft 16 comprises a flange 16a connected to the inner housing 14 inhibited the rotation around the axis V to the outer housing 12 and hence the fuselage 1, and double cylinder-like inner fixed shaft 16b and outer fixed shaft 16c integrally bonded on their lower end portions to the flange 16a.

At the insides of the inner housing 14 and the inner fixed shaft 16b is rotatably supported a cylindrical input shaft 17 around the axis V through radial bearing and thrust bearing, while a lower portion of a cylindrical upper fixed shaft 18 is fixed by threading to an upper end portion of the inner fixed shaft 16b. Between the upper fixed shaft 18 and the outer fixed shaft 16c is rotatably supported a cylindrical upper rotation shaft 19a around the axis V through radial bearing and thrust bearing, and a cylindrical lower rotation shaft 19b is rotatably supported at the outside of the outer fixed shaft 16c around the axis V through radial bearing and thrust bearing. These upper rotation shaft 19a and lower rotation shaft 19b constitute a rotary shaft 19.

To au outer peripheral face of each of the upper rotation shaft 19a and the lower rotation shaft 19b are fixed the two support shafts 8 protruding in opposite directions from each other. These support shafts 8 swingably support the base portions 3a of the upper or lower paired rotor blades 3 around the axis C perpendicular to the axis V and extending in the diameter direction of the upper rotation shaft 19a or lower rotation shaft 19b through radial bearing and thrust bearing, respectively.

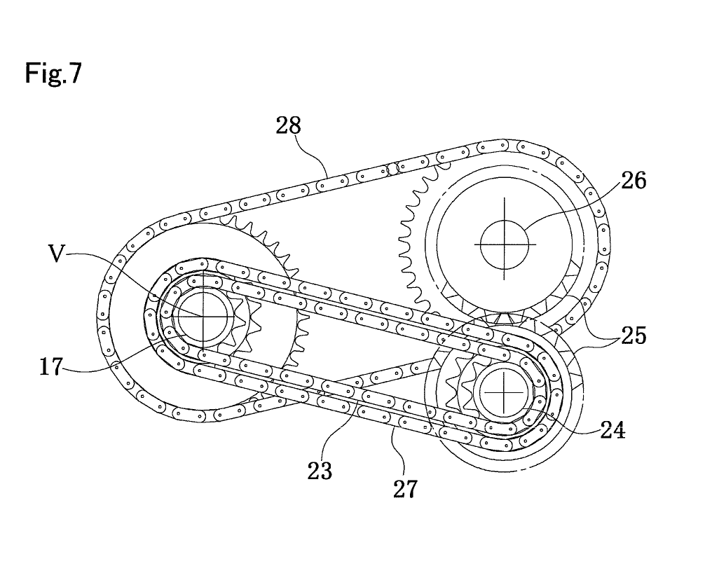

FIG. 7 is a plan view illustrating a power transmission system in the rotor blade system for helicopter. Here, an output shaft 22 of an engine is connected to a lower end portion of the input shaft 17 shown in FIG. 6 through a universal coupling 21. As shown in FIG. 7, driving rotation input from the output shaft 22 with a clutch (not shown) to the input shaft 17 is transmitted to a first driving shaft 24 through a chain 23 engaging with sprockets, and rotation of the first driving shaft 24 is transmitted to a second driving shaft 26 at equal speed and backspin through gear couplings 25 disposed on the first driving shaft 24 and the second driving shaft 26 adjacent thereto, and rotation of the first driving shaft 24 is transmitted to an upper rotation shaft 19a shown in FIG. 6 at equal speed through a chain 27 engaging with sprockets, and rotation of the second driving shaft 26 is transmitted to a lower rotation shaft 19b shown in FIG. 6 at equal speed through a chain 28 engaging with sprockets, whereby a pair of upper rotor blades 3 supported by the upper rotation shaft 19a and a pair of lower rotor blades 3 supported by the lower rotation shaft 19b are rotated in opposite directions to each other and at equal speeds as shown by arrows in FIG. 2 to generate equal lifts to each other while annihilating reaction force of rotary driving of rotor blades each other to thereby fly the helicopter stably. Moreover, the power transmission system is encompassed with a cover 29 as shown in FIGS. 5 and 6.

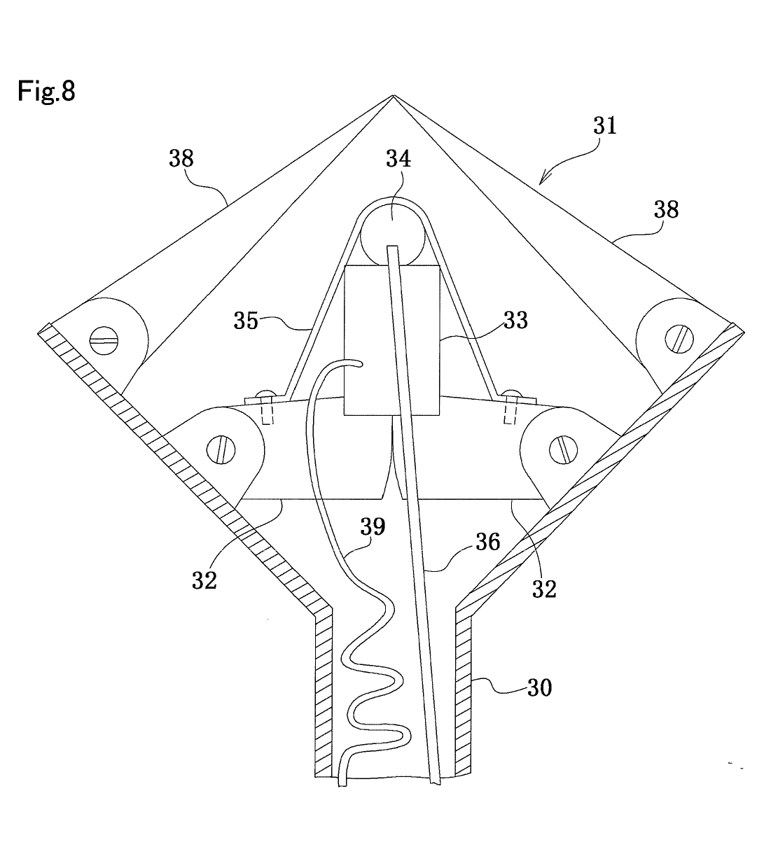

FIG. 8 is a section view illustrating a parachute ejecting device disposed on an upper end portion of the rotor mast in the rotor blade system for helicopter. As shown in this figure, a parachute storing cylinder 30 is placed inside the upper fixed shaft 18 and fixed at its upper end portion to the upper fixed shaft 18 through a flange as shown in FIG. 6, while a parachute ejecting device 31 is disposed on the upper end portion of the parachute storing cylinder 30. The parachute ejecting device 31 is constituted by arranging an ejection cylinder 33 filled with explosive on mutually facing swingable supports 32, placing a weight 34 for drawing a parachute on the ejection cylinder 33 and fixing to the supports 32 together with the ejection cylinder 33 through a band 35, connecting the weight 34 to a folded parachute 37 stored in the parachute storing cylinder 30 as shown in FIG. 1(b) through a rope 36, and encompassing them with an openable, conically-shaped cover 38.

An electric wire 39 igniting the explosive in the ejection cylinder 33 is guided to a lower end portion of the inner fixed shaft 16b through a sleeve 40 passing central holes of the inner fixed shaft 16b and the input shaft 17 and connected to an ignition device (not shown) through brushes 42, 43 attached to the lower end portion of the inner fixed shaft 16b and the inner housing 14 and slidably contacting with surfaces of slip rings 41 arranged on inner and outer peripheries of the lower end portion of the input shaft 17, respectively. Thus, when the explosive in the ejection cylinder 33 is ignited by the ignition device through application of current to the wire 39, the band 35 is torn by the weight 34 through explosion of the explosive and the weight 34 opens the cover 38 while drawing the folded parachute 37 stored in the parachute storing cylinder 30 with the rope 36, and hence the parachute 37 is ejected just above and opened above the rotor mast 2 as shown by phantom lines in FIG. 1(b).

Further, the mast-tilting support mechanism 11 in the rotor blade system for helicopter comprises two mast support wires 44 connecting and supporting the base portion of the rotor mast 2 to the fuselage 1 for obstructing the rotor mast 2 from tilting behind the fuselage 1 as shown in FIG. 5. Concretely, the mast support wires 44 pass through the cover 29 and connect the flange 16a to the outer housing 12 though they are not shown in FIG. 6. The mast support wires 44 are loosened when the rotor mast 2 tilts toward front and sides of the fuselage 1, and hence the tilting is made possible.

Therefore, when the rotor blade system for helicopter is subjected to wind from before the forward direction during the usual flying or when it is accidentally subjected to strong opposing wind, the increase of lift in the rotor blades 3 rotating toward the forward direction is suppressed, and at the same time the decrease of lift in the rotor blades 3 rotating toward the backward direction is suppressed as mentioned above, so that the balance of lift between the right and left of the fuselage 1 can be maintained and the control of the fuselage 1 can be easily conducted. Even if the fuselage 1 is accidentally subjected to strong following wind from behind, the balance of lift between the right and left of the fuselage 1 can be maintained, and even if the fuselage 1 is accidentally subjected to strong crosswind from any sides thereof, the balance of lift between the front and back of the fuselage 1 can be maintained. Even in these cases, the control of the fuselage 1 can be easily conducted. Therefore, even in helicopters silently flying by rotating rotor blades of wide-width shape having a relatively small ratio of length to width, the control of the fuselage can be controlled easily when being subjected to the gust.

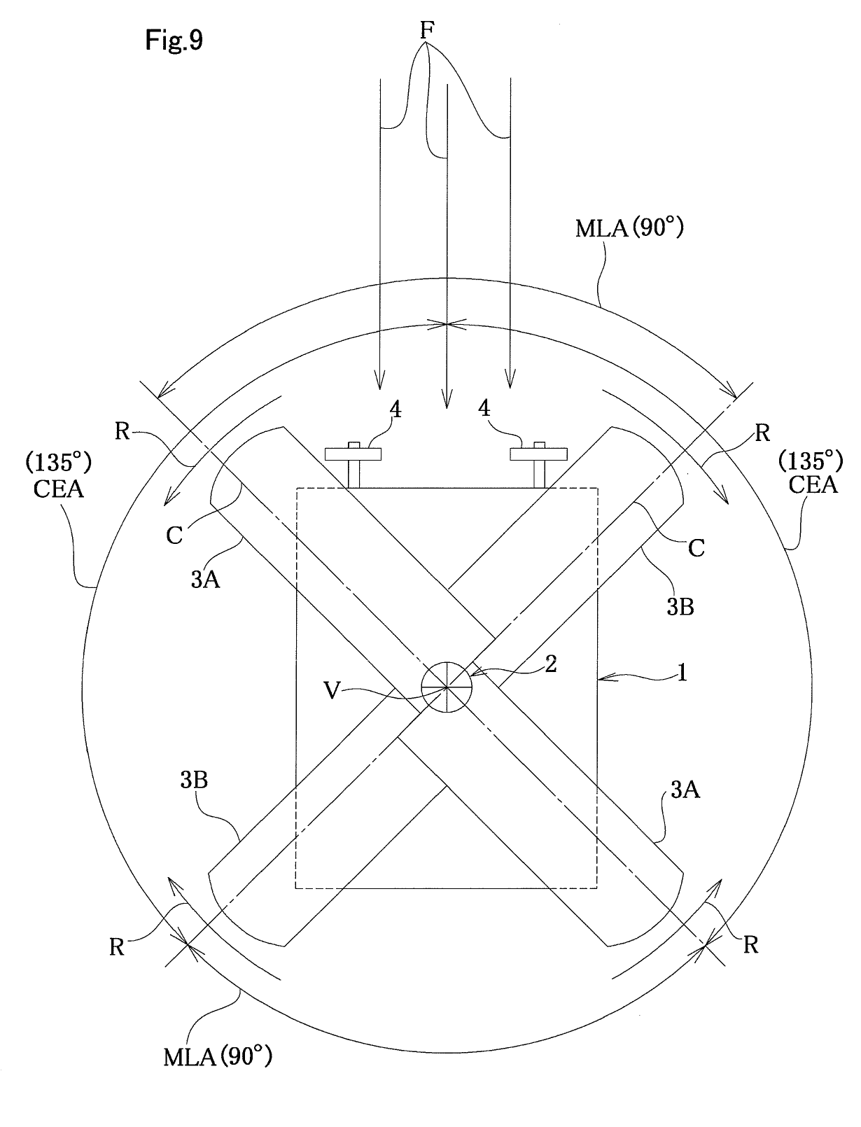

FIG. 9 is a plan view explaining an operation state of the rotor blade system for helicopter viewed from above the fuselage, wherein the fuselage 1 flies forward while being subjected to an opposing wind F from front and each of the upper rotor blades 3A and the lower rotor blades 3B rotates in a direction shown by an arrow R around the axis V of the rotor mast 2. At this state, right and left zones of 45° with respect to front or back direction of the fuselage 1 are zones MLA that each of the upper rotor blades 3A and the lower rotor blades 3B goes across the opposing wind F and these rotor blades 3A and 3B are most stable and lift becomes largest. Also, right and left zones of 135° with respect to the front of the fuselage 1 are zones CEA that the upper rotor blades 3A and the lower rotor blades 3B rotate at equal elevation angles to each other and the same lift between the right and left of the fuselage 1 is obtained, so that the fuselage 1 can fly stably without causing right and left swinging. Even if the fuselage is subjected to crosswind, the upper rotor blades 3A and the lower rotor blades 3B act equally to each other as seen by rotating FIG. 9 by 90° in a direction toward the crosswind, and the fuselage 1 can be flied stably.

Since the rotor blade system for helicopter is provided with the mast-tilting support mechanism 11 with the semispherical bearing 10 tiltably supporting the rotor mast 2 on the upper portion of the fuselage 1 in right and left side directions and front direction of the fuselage 1, if the fuselage 1 is subjected to strong gust hardly dealing with only the change of elevation angle of the rotor blade from left and right sides or behind, only the rotor mast 2 is tilted in a direction opposite to the direction of the gust to keep the fuselage 1 horizontally, while the base portion of the rotor blade 3 of wide-width shape and the base portion of the rotor mast 2 can be prevented from breakage due to concentration of load based on the gust.

According to the rotor blade system for helicopter, the mast-tilting support mechanism 11 comprises the mast support wires 44 connecting and supporting the rotor mast 2 to the fuselage 1 for preventing the rotor mast 2 behind the fuselage 1, so that if the fuselage 1 is subjected to the strong gust from before, tilting backward of only the rotor mast 2 can be prevented by the mast support wires 44 for avoiding the obstruction of forward movement of the fuselage 1, while the base portion of the rotor blade 3 of wide-width shape and the base portion of the rotor mast 2 can be prevented from breakage due to concentration of load based on the gust.

In the rotor blade system for helicopter, the parachute ejection device 31 is further provided on the upper end portion of the rotor mast 2, so that the parachute 37 can be ejected just above without entangling to the rotor blades 3, and hence the fuselage can be landed slowly and safely in the engine trouble or the like.

According to the rotor blade system for helicopter, the rotor blades 3 are two pairs and the two-paired rotor blades 3 constitute double reverse blades rotating in opposite directions to each other, so that the fuselage 1 is never rotated by the reaction force of rotary driving of the rotor blades 3 even if an auxiliary rotor is not used.

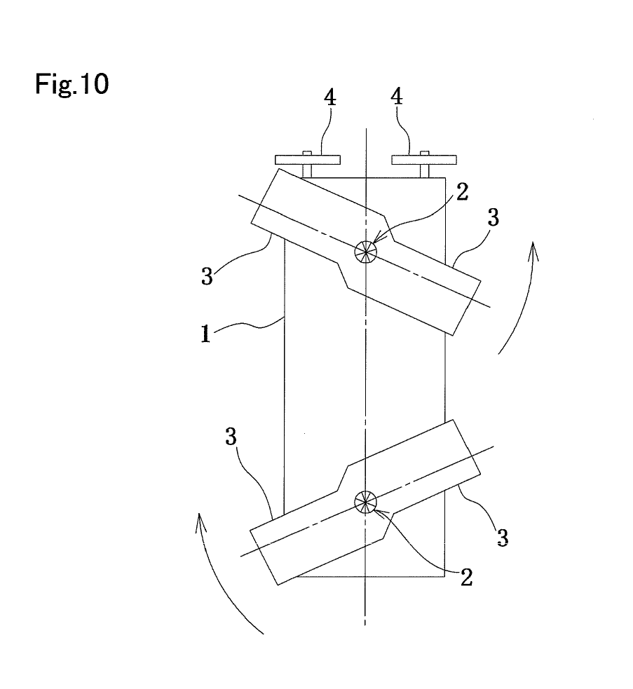

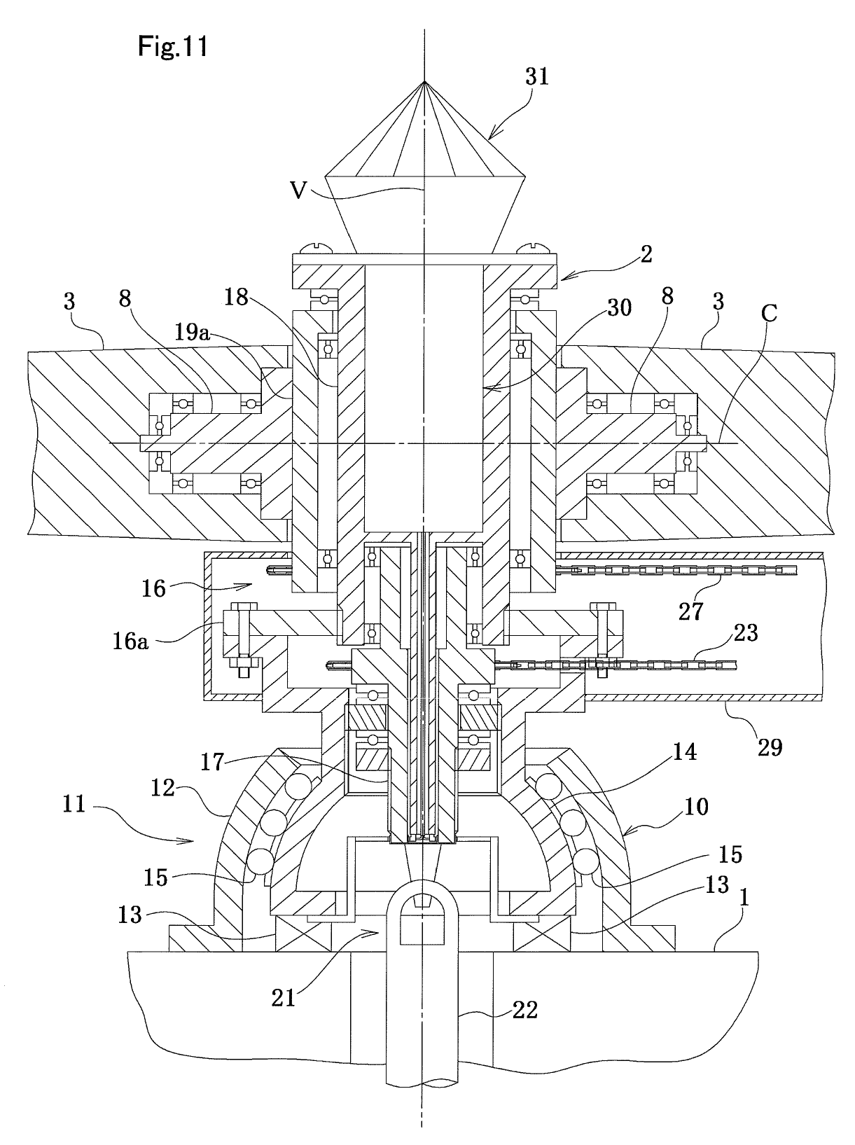

FIG. 10 is a plan view illustrating a helicopter provided with another rotor blade system for helicopter, and FIG. 11 is a section view illustrating a main part of this rotor blade system for helicopter viewing from a side of a fuselage. This rotor blade system for helicopter is different from the previous example mainly in a point that the rotor mast 2 is provided on each of the front and back portions of the fuselage 1, and the other points are constituted in the same manner as the previous example, so that the different point is mainly explained below. Moreover, the same parts as in the previous example are indicated by the same numerals, respectively.

In the helicopter provided with the latter rotor blade system for helicopter, the rotor masts 2 are disposed on the upper portion of the fuselage 1 at the front and back portions thereof, while two sets of propellers 4 for forward movement driven by an engine are provided on the front part of the fuselage 1. In the rotor mast 2 at the front portion of the fuselage 1, as shown in FIG. 11, the input shaft 17 connected to the output shaft 22 of the engine through the universal coupling 21 is rotatably supported inside the inner housing 14 of the semispherical bearing 10 in the mast-tilting support mechanism 11 and inside the upper fixed shaft 18 connected thereto through the flange 16a of the lower fixed shaft 16 around the axis V through radial bearings and thrust bearings, while the upper rotation shaft 19 is rotatably supported outside the upper fixed shaft 18 around the axis V through radial bearings and thrust bearings. Moreover, the mast-tilting support mechanism 11 has also mast support wires 44 though they are not shown.

Also, two support shafts 8 are protruded from the outer peripheral face of the upper rotation shaft 19a and fixed thereto in opposite directions to each other. The base portions 3a of the paired rotor blades 3 at the front portion of the fuselage 1 are swingably supported by these support shafts 8 around the axis C perpendicular to the axis V and extending in the diameter direction of the upper rotation shaft 19a through radial bearings and thrust bearings, respectively.

Also, the rotor mast 2 on the back portion of the fuselage 1 is provided with the construction similar to the rotor mast 2 on the front portion of the fuselage 1, and the input shaft 17 thereof is connected to another output shaft 22 synchronously rotating with the output shaft 22 of the engine through a universal coupling 21. According to such a construction, the rotation transmitted from the input shaft 17 in the front rotor mast 2 of the fuselage 1 to the first driving shaft 24 through the chain 23 of the same transmission mechanism as shown in FIG. 7 (however, the gear couplings 25, second driving shaft 26 and chain 28 are excluded) is transmitted to the upper rotation shaft 19a in the front rotor mast 2 of the fuselage 1 through the chain 27 at equal speed and in the same rotating direction to rotate the front rotor blades 3, while the rotation transmitted from the input shaft 17 in the back rotor mast 2 of the fuselage 1 to the first driving shaft 24 through the chain 23 of the same transmission mechanism as shown in FIG. 7 is transmitted to the upper rotation shaft 19a in the back rotor mast 2 of the fuselage 1 through the gear couplings 25, second driving shaft 26 and chain 28 at equal speed and in the reverse rotating direction to rotate the back rotor blades 3, so that the front paired rotor blades 3 and the back paired rotor blades 3 are rotated in opposite directions and at equal speed to each other as shown by arrows in FIG. 10 while changing the elevation angles against the gust, respectively.

Even in this rotor blade system foe helicopter, therefore, the helicopter can be flied stably against the gust likewise the previous example. Also, when the front and back rotor masts 2 of the fuselage 1 are subjected to the gust, respectively, they can be swung independently to the fuselage 1 by the mast-tilting support mechanism 11 having the mast support wires 44, so that if the fuselage 1 is subjected to strong gust hardly dealing with only the change of the elevation angle in the rotor blades from the right and left sides or behind, only the rotor masts are tilted in a direction opposing to the gust direction to keep the fuselage 1 horizontally, while the base portion of the rotor blade 3 of wide-width shape and the base portion of the rotor mast 2 can be prevented from breakage by the concentration of load due to the gust.

Even in this rotor blade system for helicopter, the mast-tilting support mechanism 11 has mast support wires 44 connecting and supporting the rotor mast 2 to the fuselage 1 for blocking the tilting of the rotor mast 2 behind the fuselage 1, so that if the fuselage 1 is subjected to the strong gust from before, tilting backward of only the rotor masts 2 are prevented by the mast support wires 44 to avoid the fuselage 1 from blocking in the forward flying movement, while the base portion of the rotor blade 3 of wide-width shape and the base portion of the rotor mast 2 can be prevented from breakage by the concentration of load due to the gust.

Further, the rotor blade system for helicopter is also provided the parachute ejection device 31 on the upper end portion of the rotor mast 2, so that the parachute 37 can be ejected just above without entangling to the rotor blades 3, and hence the fuselage can be landed slowly and safely at the time of causing engine trouble or the like.

Even in this rotor blade system for helicopter, since there are two pairs of rotor blades 3 and the two paired rotor blades are rotated in opposite directions to each other, the fuselage 1 is never rotated by reaction force of rotary driving of the rotor blade 3 if an auxiliary rotor is not used.

Although the invention is described with reference to the above illustrated examples, it is not limited to the above examples and may be properly modified within a scope of the claims. For example, although one or two rotor masts 2 are used in the above examples, three or more rotor masts may be used provided that each of the rotor mast has paired rotor blades. In the above examples, the two paired rotor blades are rotated in opposite directions to each other, but one pair or plural pairs of rotor blades 3 may be rotated in the same direction as in usual small-size helicopters and the rotation of the fuselage 1 due to reaction force of rotary driving of the rotor blades 3 may be stopped by an auxiliary rotor or the like disposed on the back portion of the fuselage.

Although the parachute ejection device 31 at the upper end portion of the rotor mast 2, mast-titling support mechanism 11 and mast support wires 44 are provided in the above examples, at least one of them may be omitted, if necessary. In the above examples is arranged the power transmitted system on the base portion of the rotor mast 2 at the outside of the fuselage, but it may be housed in the inside of the fuselage for reducing resistance to air during the flying, if necessary. Although the fuselage 1 is substantially box type in the above examples, resistance to air during the flying may be reduced by making the fuselage 1 to an oval shape, streamline shape or the like, if necessary.

### INDUSTRIAL APPLICABILITY

According to the rotor blade system for helicopter of the invention, when the fuselage is subjected to wind from before during the usual forward flying movement, or when the fuselage is accidentally subjected to strong opposing wind, the increase of lift in the rotor blades rotating in the direction of forward movement is suppressed, while the decrease of lift in the rotor blades rotating in the direction of backward movement is suppressed, so that the balance of lift between the right and left of the fuselage can be maintained. Similarly, even when the fuselage is accidentally subjected to strong opposing wind from behind, the balance of lift between the right and left of the fuselage can be maintained, while even when the fuselage is accidentally subjected to strong crosswind from either left or right side, the balance of lift between the front and back of the fuselage can be maintained, so that the control of the fuselage can be easily conducted when being subjected to the gust even in helicopters silently flying while slowly rotating the rotor blades of wide-width shape.

### DESCRIPTION OF REFERENCE SYMBOLS

1 fuselage
1a window
2 rotor mast
3 rotor blade
3A upper rotor blades
3B lower rotor blades
3a base portion
4 propeller
5 horizontal stabilizer
6 vertical fin
7 wheel
8 support shaft
9 stopper
10 semispherical bearing
11 mast-tilting support mechanism
12 outer housing
13 spring
14 inner housing
15 steel ball
16 fixed shaft
16a flange
16b inner fixed shaft
16c outer fixed shaft
17 input shaft
18 upper fixed shaft
19 rotary shaft
19a upper rotation shaft
19b lower rotation shaft
21 universal joint
22 output shaft
23, 27, 28 chain
24 first driving shaft
25 gear couplings
26 second driving shaft
29, 38 cover
30 parachute storing cylinder
31 parachute ejection device
32 support
33 ejection cylinder
34 weight
35 band
36 rope
37 parachute
39 electric wire
40 sleeve
41 slip ring
42, 43 brush
44 mast support wire
C, V axis

1. A rotor blade system for helicopter comprising a rotor mast vertically disposed on an upper part of a fuselage in the vicinity of its position of the center of gravity, even-ordered rotor blades supported on their base portions by the rotor mast, and a power source rotary-driving the rotor mast to rotate the plural rotor blades around an axis of the rotor mast, the even-ordered rotor blades are arranged at equal intervals in a circumferential direction of the rotor mast such that each two rotor blades hold the rotor mast there between and extend in a diametrical direction of the rotor mast as a pair, and that the paired two rotor blades are integrally joined with each other at their base portions and are swingably supported around a common axis extending in the diametrical direction of the rotor mast by a support shaft perpendicularly positions in the rotor mast, and that the support shaft provides an elevation angle from horizontal posture to the rotor blade and supports the rotor blade at a position between front and rear blade ends, the elevation angle decreases as the rotor blade is subjected to wind pressure from ahead of the rotation direction of the rotor blade, a mast-tilting support mechanism having a semispherical bearing and tiltably supporting the rotor mast on the upper part of the fuselage in all directions of right-left sides and front of the fuselage, and that the rotor mast comprises a rotary shaft rotating the rotor blades around an axis of the rotor mast and a fixed shaft located inside the rotary shaft and supported so as not to rotate to with respect to the fuselage, and a parachute ejection device is provided on an upper end part of the fixed shaft of the rotor mast.

2. (canceled)

3. A rotor blade system for helicopter according to claim 1, wherein the mast-tilting support mechanism is provided with mast support wires supporting the rotor mast connected to the fuselage for preventing the rotor mast from tilting behind the fuselage.

4. (canceled)

5. A rotor blade system for helicopter according claim 1, wherein the rotor blades are used pairs of two and the pairs of the rotor blades are rotated in directions opposite to each other.

6. A rotor blade system for helicopter according to claim 3, wherein the rotor blades are used in pairs of two and the pairs of the rotor blades are rotated in directions opposite to each other.
